(19) United States
(12) Patent Application Publication
(10) Pub. No.: US 2020/0167005 A1
(43) Pub. Date: May 28, 2020

(54) RECOGNITION DEVICE AND RECOGNITION METHOD

(71) Applicant: SEIKO EPSON CORPORATION, Tokyo (JP)

(72) Inventors: Yuya MARUYAMA, Fuefuki-shi (JP); Hideki TANAKA, Chino-shi (JP)

(73) Assignee: SEIKO EPSON CORPORATION, Tokyo (JP)

(21) Appl. No.: 16/697,473

(22) Filed: Nov. 27, 2019

(30) Foreign Application Priority Data
Nov. 28, 2018 (JP) 2018-221853
Jun. 14, 2019 (JP) 2019-110806

(51) Int. Cl. G06F 3/01; G06T 7/73; G06F 3/03; G06T 7/593; G02B 27/01

(52) U.S. Cl. CPC G06F 3/017; G06T 7/73; G06F 3/0304; G06T 2207/10028; G02B 27/017; G06T 2207/30244; G06T 7/593

(57) ABSTRACT

A recognition device includes a monocular camera that captures an image of a pointer and a space coordinate estimation unit that estimates a space coordinate of a tip portion of the pointer based on the image. The space coordinate estimation unit includes a pointer detection unit that detects the pointer from the image and a depth coordinate estimation unit that estimates a depth coordinate of the tip portion of the pointer based on a shape of the pointer in the image.

The present application is based on, and claims priority from JP Application Serial Number 2018-221853, filed Nov. 28, 2018 and JP Application Serial Number 2019-110806, filed Jun. 14, 2019, the disclosures of which are hereby incorporated by reference herein in its entirety.

### BACKGROUND

### 1. Technical Field

The present disclosure relates to a recognition technique for recognizing a space coordinate of a pointer of an operator.

### 2. Related Art

JP-A-2018-010539 discloses a system that captures an image of a hand by a monocular camera and identifies a rotation operation and a swipe operation of the hand.

However, in the technique in the related art, only two-dimensional movements of a hand on a plane perpendicular to the optical axis of the camera can be detected, and a three-dimensional position of a hand cannot be recognized. For this reason, in the related art, a technique for recognizing a three-dimensional position of a hand has been desired. An advantage of some aspects of the present disclosure is to solve a problem common to a case of recognizing a three-dimensional position of another type of pointer as well as a hand.

### SUMMARY

According to an aspect of the present disclosure, there is provided a recognition device that recognizes a space coordinate of a pointer of an operator. The recognition device includes a monocular camera that captures an image of the pointer and a space coordinate estimation unit that estimates a space coordinate of a tip portion of the pointer based on the image. The space coordinate estimation unit includes a pointer detection unit that detects the pointer from the image and a depth coordinate estimation unit that estimates a depth coordinate of the tip portion of the pointer based on a shape of the pointer in the image.

### BRIEF DESCRIPTION OF THE DRAWINGS

FIG. 1 is a block diagram of a pointer recognition system.

FIG. 2 is a functional block diagram of a head-mounted display device according to a first embodiment.

FIG. 3 is a flowchart illustrating a procedure of space coordinate estimation processing.

FIG. 4 is an explanatory diagram illustrating an image including a pointer.

FIG. 5 is a graph illustrating an example of a conversion equation of a depth coordinate.

FIG. 6 is a flowchart of pointer region detection processing.

FIG. 7 is a flowchart of tip portion detection processing.

FIG. 8 is a flowchart of depth coordinate estimation processing.

FIG. 9 is an explanatory diagram illustrating a manner of a touch operation.

FIG. 10 is an explanatory diagram illustrating a manner of a swipe operation.

FIG. 11 is a flowchart of depth coordinate estimation processing according to a second embodiment.

FIG. 12 is an explanatory diagram illustrating processing contents of the depth coordinate estimation processing.

FIG. 13 is a flowchart of depth coordinate estimation processing according to a third embodiment.

FIG. 14 is an explanatory diagram illustrating processing contents of the depth coordinate estimation processing.

FIG. 15 is a functional block diagram of the head-mounted display device according to a fourth embodiment.

FIG. 16 is an explanatory diagram illustrating a configuration example of a space coordinate estimation unit according to the fourth embodiment.

### DESCRIPTION OF EXEMPLARY EMBODIMENTS

### A. First Embodiment

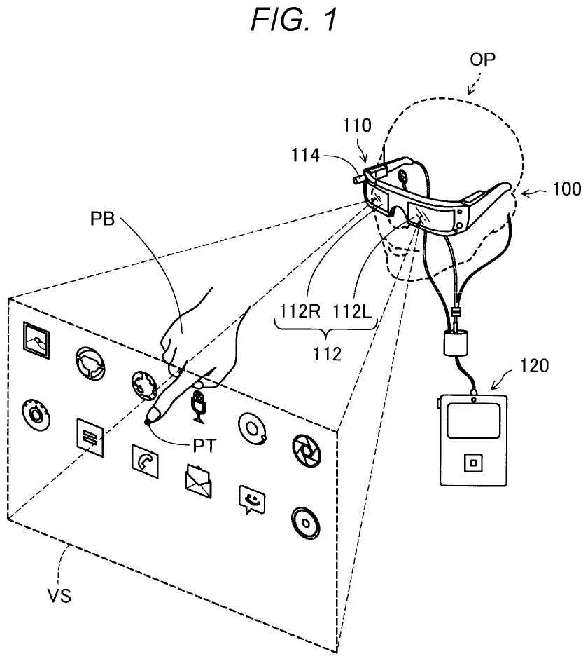

FIG. 1 is a block diagram of a pointer recognition system according to a first embodiment. The pointer recognition system is configured with a head-mounted display device 100 mounted on a head of an operator OP. The head-mounted display device 100 recognizes a space coordinate of a finger as a pointer PB.

The head-mounted display device 100 includes an image display unit 110 that allows the operator OP to visually recognize an image, and a control unit 120 that controls the image display unit 110. The image display unit 110 is configured as a mounting body to be mounted on the head of the operator OP, and has an eyeglass shape in the present embodiment. The image display unit 110 includes a display unit 112 including a right-eye display unit 112R and a left-eye display unit 112L, and a camera 114. The display unit 112 is a light-transmissive display unit, and is configured to allow the operator OP to visually recognize an external view viewed through the display unit 112 and an image displayed by the display unit 112. That is, the head-mounted display device 100 is alight-transmissive head-mounted display that performs displaying by popping up the image displayed by the display unit 112 on the external view viewed through the display unit 112.

In the example of FIG. 1, the display unit 112 displays a virtual screen VS in an external space, and the operator OP performs an operation on the virtual screen VS by using the pointer PB. In the present embodiment, the pointer PB is a finger. The head-mounted display device 100 functions as a recognition device that recognizes a space coordinate of a tip portion PT of the pointer PB by capturing an image including the pointer PB by using the camera 114 and processing the image. The head-mounted display device 100 further recognizes an operation on the virtual screen VS based on the recognized space position and a trajectory of the tip portion PT of the pointer PB, and performs processing according to the operation. As the camera 114, a monocular camera is used.

The recognition device that recognizes the pointer PB is not limited to the head-mounted display device 100, and another type of device may also be used. In addition, the pointer PB is not limited to a finger, and another object such as a pointing pen or a pointing rod used by the operator OP to input an instruction may be used.

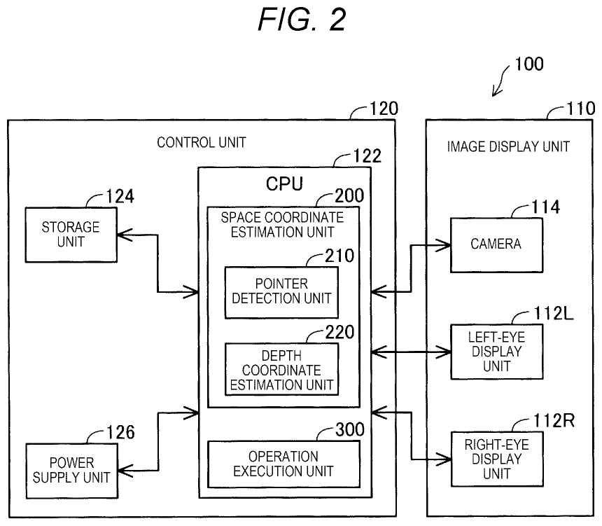

FIG. 2 is a functional block diagram of the head-mounted display device 100 according to the first embodiment. The control unit 120 of the head-mounted display device 100 includes a CPU 122 as a processor, a storage unit 124, and a power supply unit 126. The CPU 122 functions as a space coordinate estimation unit 200 and an operation execution unit 300. The space coordinate estimation unit 200 estimates a space coordinate of the tip portion PT of the pointer PB based on the image of the pointer PB captured by the camera 114. The operation execution unit 300 executes an operation according to the space coordinate of the tip portion PT of the pointer PB.

The space coordinate estimation unit 200 includes a pointer detection unit 210 and a depth coordinate estimation unit 220. The pointer detection unit 210 detects the pointer PB from the image of the pointer PB captured by the camera 114. The depth coordinate estimation unit 220 estimates a depth coordinate of the tip portion PT of the pointer PB based on a shape of the pointer PB in the image of the pointer PB. Details of functions of the pointer detection unit 210 and the depth coordinate estimation unit 220 will be described later. In the present embodiment, the functions of the space coordinate estimation unit 200 are realized by executing a computer program stored in the storage unit 124 by the CPU 122. On the other hand, some or all of the functions of the space coordinate estimation unit 200 may be realized by a hardware circuit. The CPU 122 further functions as a display execution unit that allows the operator OP to visually recognize the image by displaying the image on the display unit 112, and the function is not illustrated in FIG. 2.

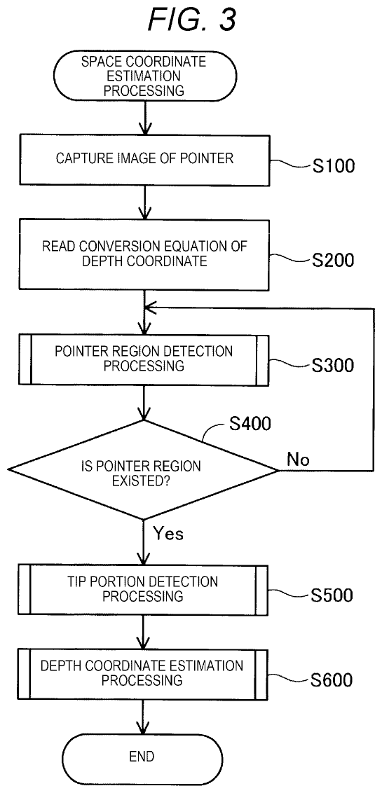

FIG. 3 is a flowchart illustrating a procedure of space coordinate estimation processing. The space coordinate estimation processing is executed by the space coordinate estimation unit 200. In step S100, the camera 114 captures an image of the pointer PB.

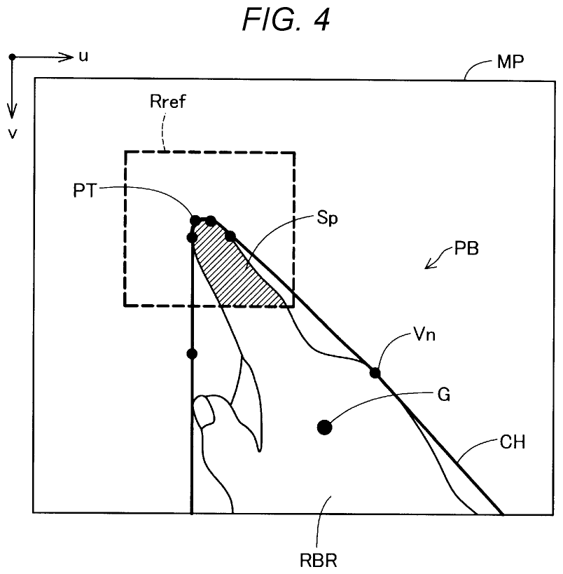

FIG. 4 is an explanatory diagram illustrating an image MP including the pointer PB. As described in detail below, in the first embodiment, a pointer region RBR as a region of the pointer PB is detected in the image MP, and a fingertip of a finger as the pointer PB is recognized as the tip portion PT of the pointer PB. Further, in the image MP, an area Sp of a tip portion region including the tip portion PT is calculated. Hereinafter, the area Sp is referred to as “tip portion area Sp”.

A position in the image MP is represented by a horizontal coordinate u and a vertical coordinate v. A space coordinate of the tip portion PT of the pointer PB may be represented by (u, v, Z) based on a two-dimensional coordinate (u, v) and a depth coordinate Z of the image MP. In FIG. 1, the depth coordinate Z is a distance from the camera 114 to the fingertip as the tip portion PT of the pointer PB.

In step S200 of FIG. 3, a conversion equation of the depth coordinate Z is read from the storage unit 124.

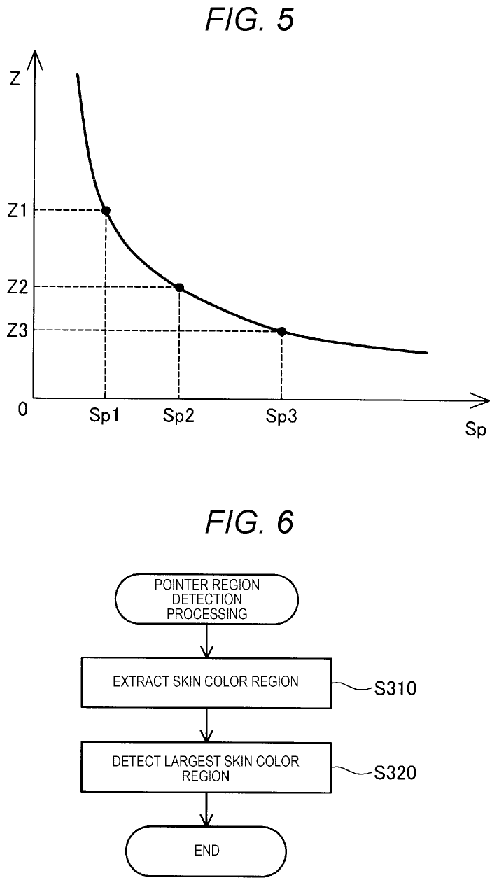

FIG. 5 is a graph illustrating an example of a conversion equation of the depth coordinate. In the first embodiment, the depth coordinate Z is given by, for example, the following equation.

Z=k/Sp^{0.5} (1)

Here, k indicates an integer, and Sp indicates a tip portion area of the pointer PB.

The equation (1) is an equation calculated using values of a plurality of points (Z1, Sp1) to (Zn, Spn) acquired in advance, and in the example of FIG. 5, n is 3.

The equation (1) indicates that the depth coordinate Z of the tip portion of the pointer PB is inversely proportional to a square root of the tip portion area Sp of the pointer PB. On the other hand, an equation representing a relationship other than the equation (1) may be used. Here, in general, a relationship between the tip portion area Sp and the depth coordinate Z is a relationship in which the depth coordinate Z increases as the tip portion area Sp of the pointer PB decreases. The relationship between the tip portion area Sp and the depth coordinate Z is determined by performing calibration in advance, and is stored in the storage unit 124. As the conversion equation of the depth coordinate Z, a form other than a function may be used. For example, a look-up table in which the tip portion area Sp corresponds to input and the depth coordinate Z corresponds to output may be used.

In step S300 of FIG. 3, the pointer detection unit 210 executes pointer region detection processing of detecting a pointer region from the image of the pointer PB.

FIG. 6 is a flowchart of pointer region detection processing. In step S310, a region having a preset skin color is extracted from the image MP. In the present embodiment, since a finger is used as the pointer PB, a region having a skin color as a color of the finger is extracted. For the extraction, an allowable color range of the skin color is set in advance, and a region in which pixels within the allowable color range are connected to each other is extracted as a skin color region. In a case where a pointer other than a finger is used, a color of the pointer may be set in advance as a pointer color, and a region of the pointer color in the image obtained by capturing the pointer may be recognized as a pointer.

In step S320, a region having the largest area among the skin color regions is detected. Here, a reason for detecting the region having the largest area among the skin color regions is to prevent a skin color region having a small area from being erroneously recognized as a finger. When step S320 is completed, the process proceeds to step S400 of FIG. 3.

Instead of detecting the pointer region using the color of the pointer PB such as a skin color, the pointer region may be detected using another method. For example, the pointer region may be detected by detecting feature points in the image MP, dividing the image MP into a plurality of small sections, and extracting a section in which the number of feature points is smaller than a predetermined threshold value. This method is based on a fact that the pointer PB such as a finger has feature points less than feature points of other image portions.

The feature points may be detected by using, for example, an algorithm such as oriented FAST and rotated BRIEF (ORB) or KAZE. The feature points detected by ORB are feature points corresponding to corners of an object. Specifically, 16 pixels around a target pixel are observed, and when pixel values of pixels around the target pixel are continuously bright or dark, the target pixel is detected as a feature point corresponding to a corner of an object. The feature points detected by KAZE are feature points representing edge portions. Specifically, the image is subjected to processing of reducing a resolution in a pseudo manner by applying a non-linear diffusion filter to the image, and a pixel of which the difference in pixel value before and after the processing is smaller than a threshold value is detected as a feature point.

In step S400 of FIG. 3, the pointer detection unit 210 determines whether or not the existence of the pointer region RBR is detected in the image MP. This determination is a determination as to whether or not the area of the skin color region detected in step S320 of FIG. 6 is within a predetermined allowable range. Here, in the allowable range of the area of the skin color region, an upper limit value is set to, for example, the area of the pointer region RBR when the depth coordinate Z of the tip portion PT is the smallest within a practical range and the pointer PB faces a direction perpendicular to the optical axis of the camera 114. In addition, in the allowable range of the area of the skin color region, a lower limit value is set to, for example, the area of the pointer region RBR when the depth coordinate Z of the tip portion PT is the largest within a practical range and the pointer PB faces a direction which is most inclined in a practical range with respect to the optical axis of the camera 114.

In step S400, in a case where the existence of the pointer region RBR is not detected, the process returns to step S300, and the pointer region detection processing described in FIG. 6 is executed again. In second and subsequent processing of step S300, the detection condition is changed so as to more easily detect the pointer region RBR. Specifically, for example, in the extraction processing of the skin color region in step S310, the allowable color range of the skin color is shifted from the range when step S300 is previously performed, or the allowable color range is expanded or reduced.

In a case where the existence of the pointer region RBR is detected in step S400, the process proceeds to step S500. In step S500, the pointer detection unit 210 executes tip portion detection processing.

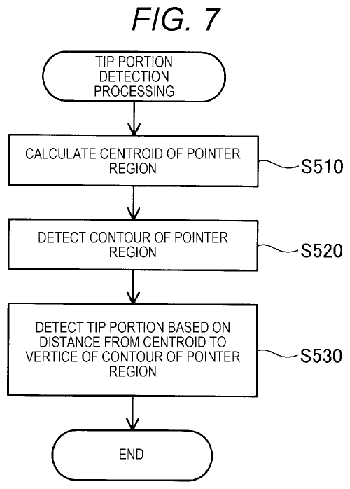

FIG. 7 is a flowchart of tip portion detection processing. In step S510, a coordinate (u, v) of the centroid G of the pointer region RBR illustrated in FIG. 4 is calculated. In step S520, a contour CH of the pointer region RBR is detected. Specifically, for example, a convex closure of the pointer region RBR is detected as the contour CH of the pointer region RBR. The contour CH is a polygon obtained by approximating an outer shape of the pointer region RBR, and is a convex polygon obtained by connecting a plurality of vertices Vn by a straight line.

In step S530, the tip portion PT of the pointer region RBR is detected based on distances from the centroid G of the pointer region RBR to the plurality of vertices Vn of the contour CH of the pointer region RBR. Specifically, among the plurality of vertices Vn, a vertex having the longest distance from the centroid G is detected as the tip portion PT of the pointer region RBR.

When the tip portion PT of the pointer PB is detected, the process proceeds to step S600 of FIG. 3. In step S600, the depth coordinate estimation unit 220 estimates a depth coordinate Z of the tip portion PT.

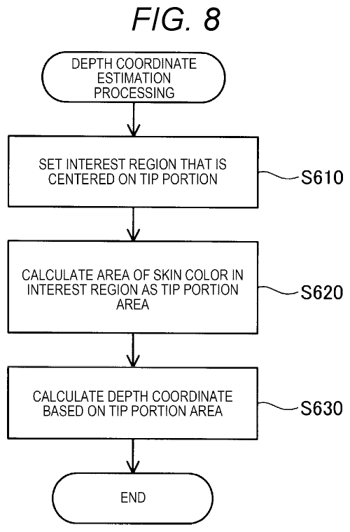

FIG. 8 is a flowchart of depth coordinate estimation processing. In step S610, an interest region Rref illustrated in FIG. 4 is set in the image MP. The interest region Rref is a region that is centered on the tip portion PT of the pointer PB and has a predetermined shape and area. In the example of FIG. 4, the interest region Rref is a square region. On the other hand, the interest region Rref may be a region having a shape other than a square, and may be, for example, a rectangular region or a circular region.

In step S620, an area of the skin color region in the interest region Rref is calculated as a tip portion area Sp. The inventor of the present application has found that the tip portion area Sp in the interest region Rref hardly depends on an inclination of the pointer PB with respect to the optical axis of the camera 114 and depends only on a distance between the tip portion PT and the camera 114. The reason why such a relationship is established as follows. Since the interest region Rref having a predetermined shape and area is set in the image MP, even when the inclination of the pointer PB with respect to the optical axis of the camera 114 is changed, only the range of the pointer PB included in the interest region Rref is changed, and the tip portion area Sp of the pointer PB may be maintained to be substantially constant.

In step S630, the depth coordinate Z of the tip portion PT is calculated based on the tip portion area Sp. This processing is executed according to the conversion equation of the depth coordinate that is read in step S200.

In the estimation processing of the depth coordinate Z, the position of the tip portion PT and the tip portion area Sp are determined according to the shape of the pointer PB in the image MP, and the depth coordinate Z is estimated according to the tip portion area Sp. Therefore, it can be considered that the depth coordinate estimation unit 220 estimates the depth coordinate Z of the tip portion PT of the pointer PB based on the shape of the pointer PB in the image MP.

When the depth coordinate Z of the tip portion PT of the pointer PB is estimated, a space coordinate (u, v, Z) of the tip portion PT of the pointer PB is obtained by combining the coordinate (u, v) of the tip portion PT in the image MP and the estimated depth coordinate Z. As the space coordinate, a three-dimensional coordinate other than (u, v, Z) may be used. For example, a three-dimensional coordinate or the like which is defined in a reference coordinate system of the head-mounted display device 100 may be used.

The operation execution unit 300 of the head-mounted display device 100 executes processing according to the position and the trajectory of the tip portion PT based on the space coordinate indicating the position of the tip portion PT of the pointer PB. As the processing according to the position and the trajectory of the tip portion PT, for example, as illustrated in FIG. 1, an operation such as a touch operation or a swipe operation may be performed on the virtual screen VS set in front of the camera 114.

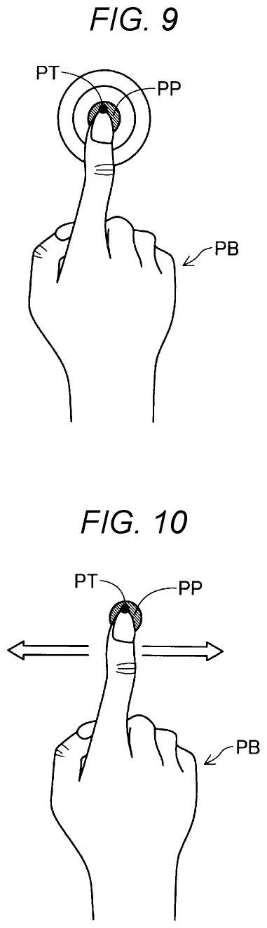

FIG. 9 is an explanatory diagram illustrating a manner of a touch operation. The touch operation is an operation of touching a predetermined position PP on the virtual screen VS with the tip portion PT of the pointer PB. In response to the touch operation, for example, processing such as selection of an object such as an icon or activation of an application may be executed.

FIG. 10 is an explanatory diagram illustrating a manner of a swipe operation. The swipe operation is an operation of moving the position PP of the tip portion PT of the pointer PB on the virtual screen VS. In response to the swipe operation, for example, processing such as movement of a selected object, switching of display, or release of locking may be executed.

As described above, in the first embodiment, the depth coordinate Z of the tip portion PT of the pointer PB is estimated based on the shape of the pointer PB in the image MP, and thus the operator OP can visually recognize the image displayed on the display unit 112 that can detect the coordinate of the tip portion PT of the pointer PB in a three-dimensional space.

### B. Second Embodiment

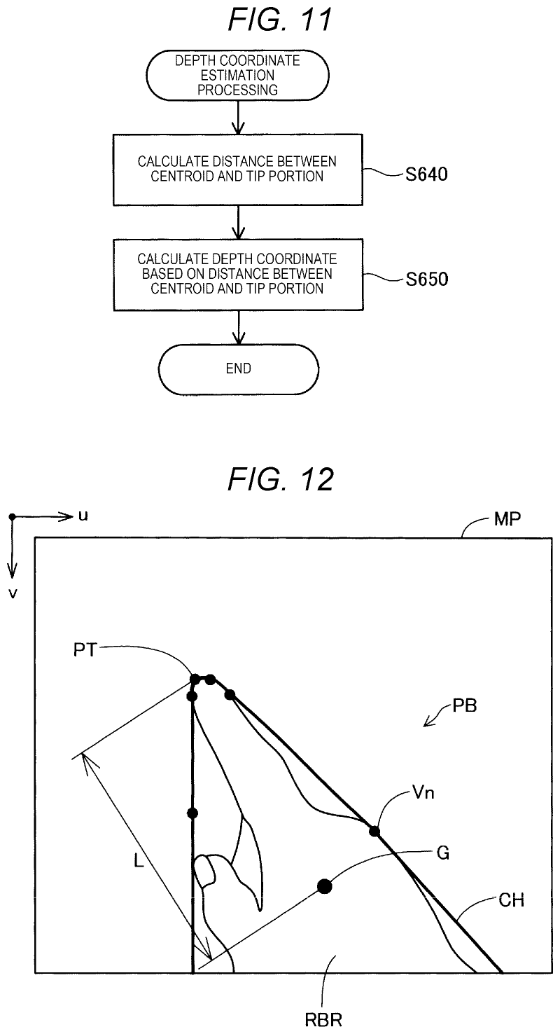

FIG. 11 is a flowchart of depth coordinate estimation processing according to a second embodiment, and FIG. 12 is an explanatory diagram illustrating processing contents of the depth coordinate estimation processing. The second embodiment differs from the first embodiment only in the detailed procedure of the depth coordinate estimation processing, and in the device configuration and processing other than the depth coordinate estimation processing, the second embodiment is substantially the same as the first embodiment.

In step S640, a distance L between the centroid G of the pointer region RBR and the tip portion PT is calculated. In step S650, a depth coordinate Z is calculated based on the distance L between the centroid G and the tip portion PT. In the processing of step S650, the conversion equation of the depth coordinate Z read in step S200 of FIG. 3 is used. Here, the conversion equation indicates a relationship between the distance L between the centroid G and the tip portion PT and the depth coordinate Z. In general, the relationship is set as a relationship in which the depth coordinate Z increases as the distance L between the centroid G and the tip portion PT decreases. The relationship between the distance L and the depth coordinate Z is determined by performing calibration in advance, and is stored in the storage unit 124.

As described above, in the second embodiment, the depth coordinate Z of the tip portion PT can be estimated by using the distance L between the centroid G of the pointer region and the tip portion PT instead of the tip portion area Sp.

### C. Third Embodiment

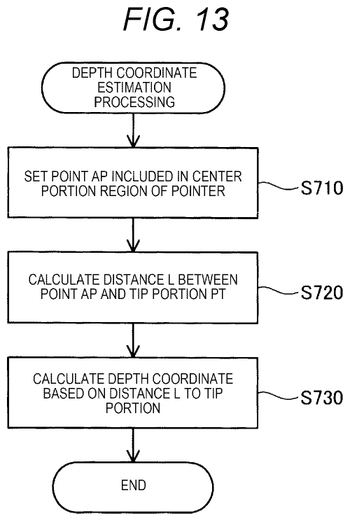

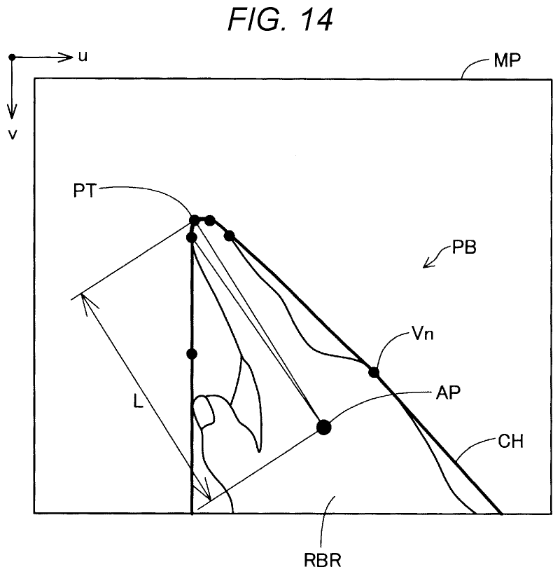

FIG. 13 is a flowchart of depth coordinate estimation processing according to a third embodiment, and FIG. 14 is an explanatory diagram illustrating processing contents of the depth coordinate estimation processing. The third embodiment differs from the first embodiment only in the detailed procedure of the depth coordinate estimation processing, and in the device configuration and processing other than the depth coordinate estimation processing, the third embodiment is substantially the same as the second embodiment.

In the third embodiment, in the depth coordinate estimation processing (FIG. 13), based on the pointer region detected in step S300, first, in step S710, processing of setting a point AP included in a center portion region of the pointer is performed. The point AP may be any point as long as the point is near the center portion of the pointer region. For example, the center portion region of the pointer may be a region that is centered on the centroid G and has a predetermined radius, or may be defined as the largest inscribed circle or the largest inscribed polygon that may be drawn in the pointer of the image. In addition, the predetermined point included in the center portion region of the pointer may be, for example, the centroid, and may be the middle point of a straight line having the longest length among straight lines passing through two points on the contour CH of the pointer. The two points are through a point on the contour CH, which is the farthest to the pointer on a boundary of image MP.

Alternatively, the point AP may be obtained by finding two straight lines, which divide the pointer region or a region surrounded by the contour CH into two regions having the same area and intersect with each other, and setting an intersection point of the two straight lines. Of course, the point AP may be a predetermined point within the inscribed circle or the like.

After the point AP is set in this way, in step S720, a distance L between the point AP and the tip portion PT is calculated, and in step S730, a depth coordinate Z is calculated based on the distance L. As in the tip portion detection processing (refer to FIG. 7), the tip portion PT may be obtained as a point on the contour CH at which the distance from the centroid G is the longest, and the tip portion PT of the pointer region RBR may be detected based on distances from the point AP set in the pointer region RBR to the plurality of vertices Vn of the contour CH of the pointer region RBR. Specifically, among the plurality of vertices Vn, a vertex having the longest distance from the point AP may be detected as the tip portion PT of the pointer region RBR.

In step S730, when calculating the depth coordinate Z based on the distance L, the conversion equation of the depth coordinate Z read in step S200 of FIG. 3 is used. Here, the conversion equation is obtained in advance as an equation indicating a relationship between the distance L between the point AP and the tip portion PT and the depth coordinate Z. In general, the relationship is set as a relationship in which the depth coordinate Z increases as the distance L between the point AP included in the center portion region of the pointer region and the tip portion PT decreases. The relationship between the distance L and the depth coordinate Z is determined by performing calibration in advance based on a setting method of the point AP in step S710, and is stored in the storage unit 124.

As described above, in the third embodiment, the depth coordinate Z of the tip portion PT can be estimated by using the distance L between the predetermined point AP of the center portion region of the pointer region and the tip portion PT instead of the centroid G of the pointer region used in the second embodiment. According to the third embodiment, the point AP is not limited to the centroid, and thus a degree of freedom in determining the point AP can be increased according to a type of the pointer or the like.

### D. Fourth Embodiment

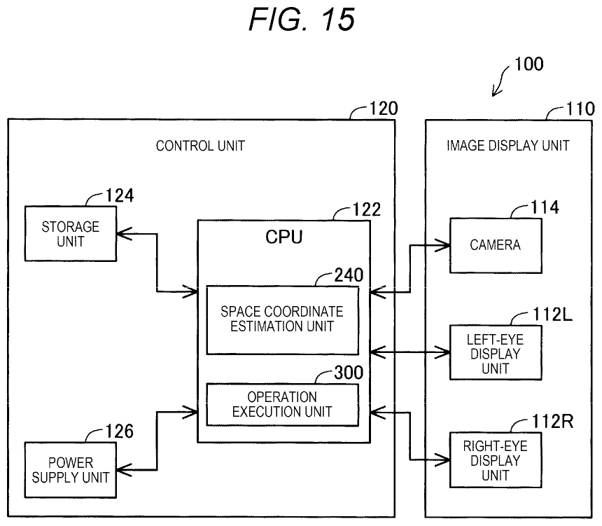

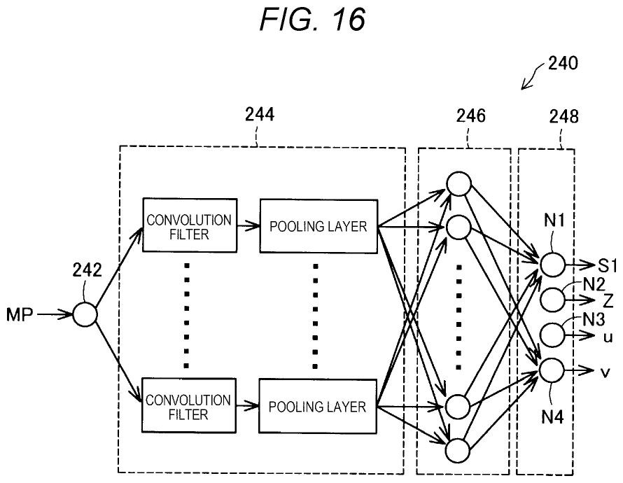

FIG. 15 is a functional block diagram of the head-mounted display device 100 according to a fourth embodiment. The head-mounted display device 100 according to the fourth embodiment differs from the head-mounted display device 100 according to the first embodiment in that the space coordinate estimation unit 240 has a configuration different from that of the space coordinate estimation unit 200 illustrated in FIG. 2, and the other device configurations of the fourth embodiment are the same as those of the first embodiment.

FIG. 16 is an explanatory diagram illustrating an example of an internal configuration of the space coordinate estimation unit 240 according to the fourth embodiment. The space coordinate estimation unit 240 is configured with a neural network, and includes an input layer 242, a middle layer 244, a fully-connected layer 246, and an output layer 248. The neural network is a convolutional neural network in which the middle layer 244 includes a convolution filter and a pooling layer. Here, a neural network other than a convolutional neural network may be used.

The image MP captured by the camera 114 is input to an input node of the input layer 242. The middle layer 244 includes a convolution filter and a pooling layer. The middle layer 244 may include a plurality of convolution filters and a plurality of pooling layers. In the middle layer 244, a plurality of pieces of feature data corresponding to the image MP are output, and the feature data is input to the fully-connected layer 246. The fully-connected layer 246 may include a plurality of fully-connected layers.

The output layer 248 includes four output nodes N1 to N4. The first output node N1 outputs a score S1 indicating whether or not the pointer PB is detected in the image MP. The other three output nodes N2 to N4 output space coordinates Z, u, and v of the tip portion PT of the pointer PB. The output nodes N3 and N4, which output two-dimensional coordinates u and v, may be omitted. In this case, the two-dimensional coordinates u and v of the tip portion PT may be obtained by another processing. Specifically, for example, the two-dimensional coordinates u and v of the tip portion PT may be obtained by the tip portion detection processing described in FIG. 7.

Learning of the neural network of the space coordinate estimation unit 240 may be performed, for example, by using parallax images obtained from a plurality of images captured by a plurality of cameras. That is, the depth coordinate Z is obtained from the parallax images, and thus it is possible to perform learning of the neural network by using, as learning data, data obtained by adding the depth coordinate Z to one image of the plurality of images.

In the space coordinate estimation unit 240 using the neural network, a section that outputs the score S1 from the first output node N1 corresponds to a pointer detection unit that detects the pointer PB from the image MP. Further, a section that outputs the space coordinate Z of the tip portion PT from the second output node N2 corresponds to a depth coordinate estimation unit that estimates the depth coordinate Z of the tip portion PT of the pointer PB based on the shape of the pointer PB in the image MP.

Even in the fourth embodiment, as in the first to third embodiments, the depth coordinate Z of the tip portion PT of the pointer PB is estimated based on the shape of the pointer PB in the image MP, and thus it is possible to detect the coordinate of the tip portion PT of the pointer PB in a three-dimensional space.

### E. Other Embodiments

The present disclosure is not limited to the above-described embodiments, and can be realized in various forms without departing from the spirit of the present disclosure. For example, the present disclosure can also be realized by the following aspect. In order to solve some or all of the problems of the present disclosure, or in order to achieve some or all of the effects of the present disclosure, the technical features in the above-described embodiments corresponding to technical features in each aspect described below may be replaced or combined as appropriate. Further, the technical features may be omitted as appropriate unless the technical features are described as essential in the present specification.

(1) According to a first aspect of the present disclosure, there is provided a recognition device that recognizes a space coordinate of a pointer of an operator. The recognition device includes a monocular camera that captures an image of the pointer and a space coordinate estimation unit that estimates a space coordinate of a tip portion of the pointer based on the image. The space coordinate estimation unit includes a pointer detection unit that detects the pointer from the image and a depth coordinate estimation unit that estimates a depth coordinate of the tip portion of the pointer based on a shape of the pointer in the image.

According to the recognition device, the depth coordinate of the tip portion of the pointer is estimated based on the shape of the pointer in the image, and thus the coordinate of the tip portion of the pointer in a three-dimensional space can be detected.

(2) In the recognition device, the depth coordinate estimation unit executes one of first processing and second processing, (a) the first processing being processing of calculating, as a tip portion area, an area of the pointer existing in an interest region which has a predetermined size and is centered on the tip portion of the pointer in the image and estimating the depth coordinate based on the tip portion area according to a predetermined relationship between the tip portion area and the depth coordinate, and (b) the second processing being processing of calculating a distance between the centroid of the pointer in the image and the tip portion and estimating the depth coordinate based on the distance according to a predetermined relationship between the distance and the depth coordinate.

According to the recognition device, the depth coordinate of the tip portion of the pointer can be estimated based on the tip portion area or the distance between the centroid of the pointer and the tip portion.

(3) In the recognition device, the pointer detection unit detects, as the pointer, a region of a predetermined skin color in the image.

According to the recognition device, the pointer such as a finger that has a skin color can be correctly recognized.

(4) In the recognition device, the pointer detection unit detects a position of a portion of the pointer that is farthest from the centroid of the pointer in the image, as a two-dimensional coordinate of the tip portion.

According to the recognition device, the two-dimensional coordinate of the tip portion of the pointer can be correctly detected.

(5) In the recognition device, the space coordinate estimation unit includes a neural network including an input node to which the image is input and a plurality of output nodes, the pointer detection unit includes a first output node that outputs whether or not the pointer exists, among the plurality of output nodes, and the depth coordinate estimation unit includes a second output node that outputs the depth coordinate of the tip portion.

According to the recognition device, the coordinate of the tip portion of the pointer in a three-dimensional space can be detected using a neural network.

(6) The recognition device further includes an operation execution unit that executes a touch operation or a swipe operation on a virtual screen, which is set in front of the monocular camera, according to the space coordinate of the tip portion estimated by the space coordinate estimation unit.

According to the recognition device, a touch operation or a swipe operation on a virtual screen can be performed using the pointer.

(7) According to a second aspect of the present disclosure, there is provided a recognition device that recognizes a space coordinate of a pointer of an operator. The recognition device includes a monocular camera that captures an image of the pointer and a space coordinate estimation unit that estimates a space coordinate of a tip portion of the pointer based on the image. The space coordinate estimation unit includes a pointer detection unit that detects the pointer from the image and a depth coordinate estimation unit that calculates a distance between a predetermined point included in a center portion region of the pointer in the image and the tip portion and estimates a depth coordinate based on the distance according to a predetermined relationship between the distance and the depth coordinate of the tip portion of the pointer.

According to the recognition device, the depth coordinate of the tip portion of the pointer can be estimated based on the distance between the predetermined point included in the center portion region of the pointer and the tip portion.

(8) In the recognition device, the pointer detection unit may detect a position of a portion of the pointer that is farthest from the predetermined point in the image, as a two-dimensional coordinate of the tip portion. According to the recognition device, a two-dimensional coordinate of the tip portion of the pointer can be correctly detected.

(9) According to a third aspect of the present disclosure, there is provided a recognition method for recognizing a space coordinate of a pointer of an operator. The recognition method includes (a) detecting the pointer from an image of the pointer captured by a monocular camera, and (b) estimating a depth coordinate of a tip portion of the pointer based on a shape of the pointer in the image.

According to the recognition method, the depth coordinate of the tip portion of the pointer is estimated based on the shape of the pointer in the image, and thus the coordinate of the tip portion of the pointer in a three-dimensional space can be detected.

What is claimed is:

1. A recognition device that recognizes a space coordinate of a pointer of an operator, the recognition device comprising:
a monocular camera that captures an image of the pointer; and
a space coordinate estimation unit that estimates a space coordinate of a tip portion of the pointer based on the image, wherein
the space coordinate estimation unit includes
a pointer detection unit that detects the pointer from the image, and
a depth coordinate estimation unit that estimates a depth coordinate of the tip portion of the pointer based on a shape of the pointer in the image.

2. The recognition device according to claim 1, wherein
the depth coordinate estimation unit executes one of first processing and second processing,
(a) the first processing being processing of calculating, as a tip portion area, an area of the pointer existing in an interest region which has a predetermined size and is centered on the tip portion of the pointer in the image and estimating the depth coordinate based on the tip portion area according to a predetermined relationship between the tip portion area and the depth coordinate, and
(b) the second processing being processing of calculating a distance between the centroid of the pointer in the image and the tip portion and estimating the depth coordinate based on the distance according to a predetermined relationship between the distance and the depth coordinate.

3. The recognition device according to claim 1, wherein
the pointer detection unit detects, as the pointer, a region of a predetermined skin color in the image.

4. The recognition device according to claim 1, wherein
the pointer detection unit detects a position of a portion of the pointer that is farthest from the centroid of the pointer in the image, as a two-dimensional coordinate of the tip portion.

5. The recognition device according to claim 1, wherein
the space coordinate estimation unit includes a neural network including an input node to which the image is input and a plurality of output nodes,
the pointer detection unit includes a first output node that outputs whether or not the pointer exists, among the plurality of output nodes, and
the depth coordinate estimation unit includes a second output node that outputs the depth coordinate of the tip portion.

6. The recognition device according to claim 1, further comprising:
an operation execution unit that executes a touch operation or a swipe operation on a virtual screen, which is set in front of the monocular camera, according to the space coordinate of the tip portion estimated by the space coordinate estimation unit.

7. A recognition device that recognizes a space coordinate of a pointer of an operator, the recognition device comprising:
a monocular camera that captures an image of the pointer; and
a space coordinate estimation unit that estimates a space coordinate of a tip portion of the pointer based on the image, wherein
the space coordinate estimation unit includes
a pointer detection unit that detects the pointer from the image, and
a depth coordinate estimation unit that calculates a distance between a predetermined point included in a center portion region of the pointer in the image and the tip portion and estimates a depth coordinate based on the distance according to a predetermined relationship between the distance and the depth coordinate of the tip portion of the pointer.

8. The recognition device according to claim 7, wherein
the pointer detection unit detects a position of a portion of the pointer that is farthest from the predetermined point in the image, as a two-dimensional coordinate of the tip portion.

9. A recognition method for recognizing a space coordinate of a pointer of an operator, the method comprising:
(a) detecting the pointer from an image of the pointer captured by a monocular camera; and
(b) estimating a depth coordinate of a tip portion of the pointer based on a shape of the pointer in the image.
